(19) United States
(12) Patent Application Publication
(10) Pub. No.: US 2009/0191898 A1
(43) Pub. Date: Jul. 30, 2009

(54) METHOD AND SYSTEM FOR IMPLEMENTING A PROXIMITY-BASED APPLICATION IN A HAND-HELD COMMUNICATIONS DEVICE

(75) Inventors: Yolanda Lewis, San Jose, CA (US); Blake Moore, Morgan Hill, CA (US)

Correspondence Address: WILSON & HAM, 2530 BERRYESSA ROAD, PMB: 348, SAN JOSE, CA, 95132, US

(73) Assignee: SNAP INC., San Jose, CA (US)

(21) Appl. No.: 12/361,497

(22) Filed: Jan. 28, 2009

Related U.S. Application Data
(60) Provisional application No. 61/024,172, filed on Jan. 28, 2008.

(51) Int. Cl. H04W 24/00

(52) U.S. Cl. 455/456.3

(57) ABSTRACT

A system and method for operating a proximity-based application on a hand-held communications device utilizing a GeoData Bar is disclosed. The system can be configured to extract proximity-specific intelligent search results from social network services, local contact services and information regarding proximity-specific contents. The search results simultaneously display with an active proximity search range on a graphical user interface (GUI) of the device corresponding to the settings of the GeoData Bar associated with the hand-held communications device. The active proximity search range includes a numeric indication of the magnitude of the active proximity search range, for example, in miles or kilometers. The GeoData Bar enables a user to interact/update/change the active proximity search range without entering any additional navigation windows or menus.

### CROSS-REFERENCE TO RELATED APPLICATIONS

This application is entitled to the benefit of provisional U.S. Patent Application Ser. No. 61/024,172, filed Jan. 28, 2008, the disclosure of which is incorporated by reference herein in its entirety.

### FIELD OF THE INVENTION

The invention relates generally to hand-held communication devices and, and more particularly, to proximity-based applications for hand-held communication devices.

### BACKGROUND OF THE INVENTION

Location-based search enables a user to search for services like restaurants, parking, fueling stations, etc, based on the user's current location. When the user performs a location-based search, the query is run against the current location of the user, a location database, and a database of location-specific content. In recent years, there has been an increase in the development of techniques for efficient location-based search in order to provide instant access to places and things at nearby locations. No longer is location-based search considered as a luxury, rather, location-based search has been widely adopted due to its convenience.

There are a number of location-based applications for hand-held communications devices and wireless networks. One such application involves matching the profiles of the attributes or characteristics of persons, places or things with the expressed preferences of the users such as travelers, to alert and direct such users to any places having attributes matching the user's express preferences. Certain applications also enable a user to set a proximity to the user that must be met to count as a match. Using these location and/or proximity based applications requires the user to navigate multiple windows/menus to initiate a user interaction.

A variety of online applications have been developed to take advantage of the extensive network capabilities of the Internet to perform location-based social networking functions. These applications generally enable people with matching interests to establish contact and meet whenever they are mutually available and interested in meeting without requiring a complicated validation period. Some other applications provide both location-based and preference-based search results to a user by matching the preferences of the person, place or thing, so as to target a user based on an explicitly stated preference. While these applications have been developed for use on desktop and laptop computers, transitioning these applications to hand-held communications devices creates unique user experience challenges.

Although various applications are available to find location-specific information, there is still a need to provide proximity-specific information to a user of a hand-held communications device in an intuitive, useful, and efficient manner.

### SUMMARY OF THE INVENTION

A technique for operating a proximity-based application on a hand-held communications device involves displaying an active proximity search range on a display of the hand-held communications device, obtaining proximity-specific content that falls within the active proximity search range, and displaying the proximity-specific content that falls within the active proximity search range on the display of the hand-held communications device simultaneously with the active proximity search range. Because the active proximity search range is simultaneously displayed with the corresponding proximity-specific content, the search range can be changed and the displayed search results can be updated without requiring the user to enter a different navigation window or menu. As a result of the simultaneously displayed search range and proximity-specific content, a user is provided with an intuitive, useful, and efficient user experience, which heretofore has not been available in a proximity-based application on a hand-held communications device.

An embodiment of a method for operating a proximity-based application on a hand-held communications device involves changing the active proximity search range without entering an additional navigation window or an additional application menu. Another embodiment of a method involves displaying the active proximity search range on the display of the hand-held communications device as the proximity-specific content is updated in response to the change in the active proximity search range. Another embodiment of a method involves interacting with the proximity specific content while the active proximity range is displayed on the hand-held communications device. In another embodiment, the active proximity search range is displayed as a sliding scale. In another embodiment, the active proximity search range includes a numeric indication of the magnitude of the active proximity search range. Additionally, the numeric indication is in miles or kilometers.

In another embodiment, a hand-held communications device includes a display for displaying a graphical user interface of an application and a proximity-based application configured to display an active proximity search range on the display, obtain proximity-specific content that falls within the active proximity search range, and display the proximity-specific content that falls within the active proximity search range on the display simultaneously with the active proximity search range.

In an embodiment of the hand-held communications device, the proximity-based application is further configured so that the active proximity search range, which is displayed on the display, can be changed without entering an additional navigation window or an additional application menu. In another embodiment, the proximity-based application is further configured to display the active proximity search range on the display of the hand-held communications device as the proximity-specific content is updated in response to a change in the active proximity search range. In another embodiment, the proximity-based application is further configured to allow a user to interact with the proximity-specific content while the active proximity search range is displayed on the hand-held communications device. In another embodiment, the proximity-based application is further configured to display the active proximity search range as a sliding scale. In another embodiment, the proximity-based application is further configured to display a numeric indication of the magnitude of the active proximity search range. Additionally, the numeric indication is in miles or kilometers. In another embodiment, the proximity-based application is further configured to display the active proximity search range as a sliding scale with a range decrease indicator on the left side of the sliding scale and a range increase indicator on the right side of the sliding scale.

In an embodiment, a hand-held communications device includes a display for displaying a graphical user interface of an application and a proximity-based social networking application configured to display an active proximity search range on the display, obtain information related to people from a specified social network that are currently located within the active proximity search range, and display an indication of the people that are currently located within the active proximity search range on the display simultaneously with the active proximity search range.

In an embodiment of the hand-held communications device, the proximity-based social networking application is further configured so that the active proximity search range, which is displayed on the display, can be changed without entering an additional navigation window or an additional application menu. In another embodiment, the proximity-based application is further configured to display the active proximity search range on the display of the hand-held communications device as the proximity-specific content is updated in response to a change in the active proximity search range. In another embodiment, the proximity-based application is further configured to allow a user to interact with the proximity-specific content while the active proximity range is displayed on the hand-held communications device. In another embodiment, the proximity-based application is further configured to display the active proximity search range as a sliding scale with a numeric indication of the magnitude of the active proximity search range in miles or kilometers.

A method for operating a proximity-based application on a hand-held communications device involves displaying an active proximity search range on a display of the hand-held communications device, wherein the active proximity search range is displayed as a sliding scale that includes a numeric indication of the magnitude of the active proximity search range in miles or kilometers, obtaining proximity-specific content that falls within the active proximity search range, displaying the proximity-specific content that falls within the active proximity search range on the display of the hand-held communications device simultaneously with the active proximity search range, changing the active proximity search range without entering an additional navigation window or an additional application menu, updating the proximity-specific content that is displayed on the display while the active proximity search range is simultaneously displayed on the Is display of the hand-held communications device, and interacting with the displayed proximity-specific content while the active proximity range is simultaneously displayed on the display of the hand-held communications device.

A hand-held communications device includes a storage media for storing computer readable instructions. When the computer readable instructions are implemented on a computer, the computer displays an active proximity search range on a display of the hand-held communications device, obtains proximity-specific content that falls within the active proximity search range, and displays the proximity-specific content that falls within the active proximity search range on the display of the hand-held communications device simultaneously with the active proximity search range.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 depicts a front view of a hand-held communications device illustrating a plurality of functional components that facilitate displaying proximity-specific content that falls within an active proximity search range.

FIG. 2 depicts a perspective view of a GeoData Bar showing the handheld communications device within a plurality of proximity search radii.

FIG. 3A depicts a diagram of a plurality of active contacts within multiple proximity search radii from at least one user of a hand-held communications device.

FIG. 3B depicts a tabular diagram of a plurality of active contacts and respective status indication of the physical location of the active contacts within a selected active proximity search range in miles or kilometers.

FIGS. 4-6 depict a front view of a hand-held communications device that displays a selected active proximity search range and populated display results related to the active contacts within the selected active proximity search range.

FIG. 7 depicts a top level diagrammatic perspective view of a system and method for utilizing a proximity-based application in an aggregated social networking platform.

FIG. 8 depicts a perspective view of a hand-held communications device configured to operate on a selected active proximity search range and a simultaneously displayed numeric indication of the active proximity search range set on a GeoData Bar.

FIG. 9 depicts a perspective view of a hand-held communications device that allows a user to navigate a plus or minus icon to increase or decrease the active proximity search range.

FIG. 10 depicts a perspective view of a hand-held communications device that displays intelligent search result information related to at least one active contact extracted from social networking services and the numeric indication of the physical location of the active contacts based on the settings of the simultaneously displayed GeoData Bar.

FIG. 11 depicts a perspective view of a hand-held communications device that displays details of an intelligent search result related to a selected active contact extracted from a plurality of social networking services and a numeric indication of the physical location of the selected active contact based on the settings of the simultaneously displayed GeoData Bar.

FIG. 12 depicts a perspective view of a hand-held communications device that allows a user to specify the proximity search range radius which the user is interested in.

FIG. 13 depicts a top level diagrammatic perspective view of proximity based widget logic that utilizes a GeoData Bar associated with a hand-held communications device.

FIG. 14 depicts a perspective view of a user interface for a hand-held communications device that displays intelligent search result information related to proximity-specific content within a selected active proximity search range.

FIG. 15 depicts a perspective view of a specific selected item of proximity-specific content, which has been identified through a proximity-specific search.

FIG. 16 depicts a perspective view of a hand-held communications device that displays intelligent search details and a numeric indication of the physical location of a proximity-specific place.

FIG. 17 depicts a perspective view of a hand-held communications device that displays populated display results of proximity-specific places within a selected active proximity search range.

FIG. 18 depicts an operational flow chart of a proximity-based application on a hand-held communications device for displaying proximity-specific content that falls within the active proximity search range based on the settings of the simultaneously displayed GeoData Bar.

FIG. 19 depicts an operational flow chart of a proximity-based application on a hand-held communications device for displaying proximity-specific content simultaneously with the active proximity search range in accordance with changes in the active proximity search range set on the GeoData Bar.

Throughout the description, similar reference numbers may be used to identify similar elements.

### DETAILED DESCRIPTION

The following description refers to embodiments of a system and method for simultaneously displaying proximity-specific content along with an active proximity search range on a hand-held communications device. In an embodiment, the following description references a system and method for utilizing proximity in an aggregated social networking platform. Similarly, proximity-specific information regarding people from a contact list is displayed on a graphical user interface (GUI) of the hand-held communications device corresponding to the settings of a GeoData Bar associated with the hand-held communications device. Furthermore, some embodiments of the described proximity logic have the ability to communicate with content providers based on search meta-tags and an active proximity search range.

A system and method for operating a proximity-based application on a hand-held communications device utilizes an active proximity search range (referred to herein as a “GeoData Bar”) to establish a proximity-based search range. The system can be configured to extract proximity-specific intelligent search results from social network services, local contact services and information regarding proximity-specific content. The search results are simultaneously displayed along with the active proximity search range on a graphical user interface (GUI) of the hand-held communications device corresponding to the setting of the GeoData Bar.

In an embodiment, the proximity-specific content generated by the application is a function of the active proximity search range set on the GeoData Bar. The proximity-specific content may be related to people, places, and/or things located within the active proximity search range that is displayed on the hand-held communications device. The GeoData Bar enables a user to interact/update/change the active proximity search range to obtain proximity-specific content that falls within the selected search range. In an embodiment, a user can touch a plus icon or a minus icon on the display to increase or decrease, respectively, the active proximity search range or the user can navigate to a plus icon or a minus icon to increase or decrease, respectively, the active proximity search range.

The active proximity search range for an intelligent search may be varied utilizing the GeoData Bar without accessing an additional navigational window or an additional application menu. The active proximity search range is displayed on the display of the hand-held communications device and the proximity-specific content is updated in response to a change in the active proximity search range. In an embodiment, the proximity based application is configured to display the active proximity search range as a sliding scale. The active proximity search range may include a numeric indication of the magnitude of the active proximity search range in, for example, miles or kilometers.

In an embodiment, a user can initiate a session for extracting proximity-based search results by setting the active proximity search range on the adjustable GeoData Bar and inputting at least one relevant search criterion. When the proximity search range is set, the hand-held communications device's location (e.g., longitude and latitude) is pushed to a server that determines the physical location of the device. The proximity-based application also facilitates the user to log in, which allows access to all accounts associated with their profile, user ID, and/or password. The proximity-based application is able to extract contents from social networking services such as Facebook, Linkedin, MySpace or the like, to which the user is registered, and from the local contact list on the hand-held communications device. A plurality of operations are performed in a server to extract intelligent search results from the server, which are then transferred to the hand-held communications device by way of a wide area network (WAN). The corresponding contacts within the active proximity search range are displayed on a graphical user interface simultaneously with the GeoData Bar. In an embodiment, the extracted populated search results are presented with a sort by option in a list format. In addition, a mapping lookup service is rendered for locating the geographic position of the proximity-specific content.

In an embodiment, proximity information in collaboration with widgets and real-time access renders smart widgets. The smart widgets are available at the presentation layer on a hand-held communications device. When a hand-held communications device comes into proximity with a matching entity such as a venue with matching meta tags or data for which a widget is parsing relevant data and current time searches are being performed, the hand-held communications device pushes this bundled query to the server which returns results based on the data set sent to the server.

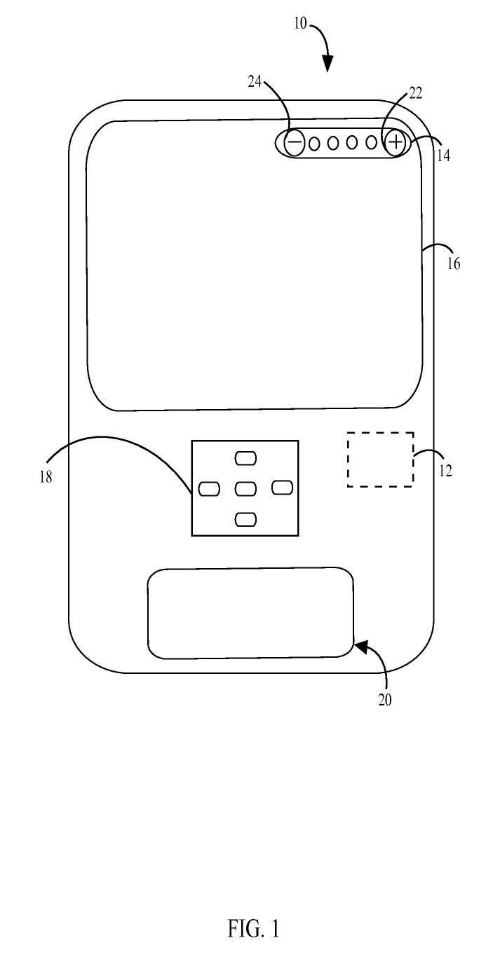

FIG. 1 depicts a front view of a hand-held communications device 10 that includes a plurality of functional components that facilitate displaying proximity-specific content that falls within an active proximity search range. The illustrated hand-held communications device 10 includes a display 16 for displaying a graphical user interface of at least one proximity-based application 12, which is embodied in computer readable instructions stored in a memory (not shown) located within the hand-held communications device. The proximity-based application is configured to display an active proximity range on the display and to obtain proximity-specific content that falls within the active proximity search range. The proximity-based application displays the proximity-specific content that falls within the active proximity search range on the display 16 simultaneously with the active proximity search range.

The proximity-specific content generated by the application is a function of the active proximity search range, which is embodied as the GeoData Bar 14. The proximity-specific content may be related to people, places, and/or things that are located within the active proximity search range that is continuously displayed on the hand-held communications device 10. The hand-held communications device 10 further includes a plurality of navigation buttons 18 and a user interface 20. The navigation buttons and user interface may include a software defined user interface and/or physically existing buttons, keys, and/or keyboard (e.g., a QWERTY keyboard.

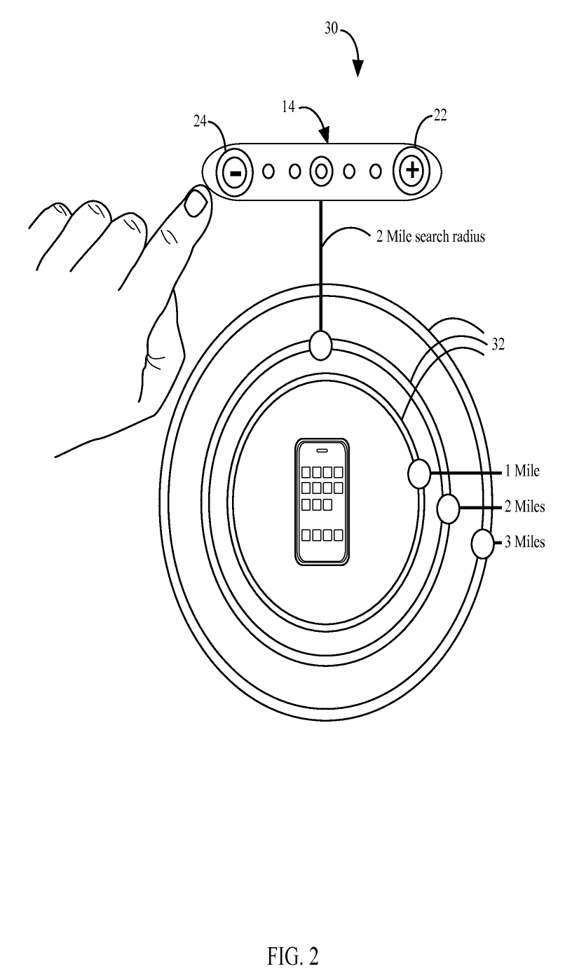

FIG. 2 depicts a perspective view of the GeoData Bar 14 showing the hand-held communications device 10 relative to multiple proximity search radii 32. The illustrated GeoData Bar 14 associated with the hand-held communications device 10 is used to set the active proximity search range within which proximity-specific content will be searched. The GeoData Bar 14 facilitates a user to interact/update/change the active proximity search range to obtain an intelligent search result of proximity-specific content within the selected search range. The GeoData Bar 14 works contextually throughout at least one application and may work with a plurality of widgets that are graphically displayed on the hand-held communications device. In an embodiment, a user can tap a plus icon 22 or a minus icon 24 on the GeoData Bar to adjust the proximity search radius or the user can navigate to the plus icon 22 or minus icon 24 and select the desired icon to increase or decrease the proximity search radius 32. These operations can be done while current proximity-specific content is displayed and without entering a different navigation window or menu. The GeoData Bar 14 controls the range of the search that is conducted to find proximity-specific content.

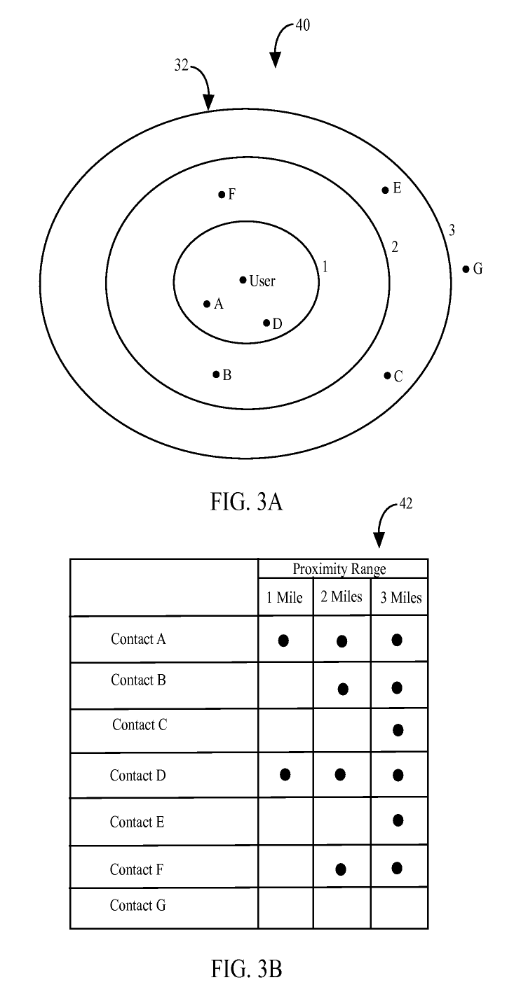

FIG. 3A illustrates multiple active contacts within the proximity search radii 32 of FIG. 2 relative to a user of the hand-held communications device 10. The active proximity search range for an intelligent search may be varied utilizing the GeoData Bar 14 without accessing an additional navigation window or an additional application menu. The active proximity search range is displayed on the display 16 of the hand-held communications device 10 and the proximity-specific content is updated in response to a change in the active proximity search range.

FIG. 3B depicts a tabular diagram 42 of a plurality of active contacts and respective status indications of the physical locations of the active contacts within a selected active proximity search range in, for example, miles. The proximity search range is simultaneously displayed on the hand-held communications device 10 along with the active proximity-specific content.

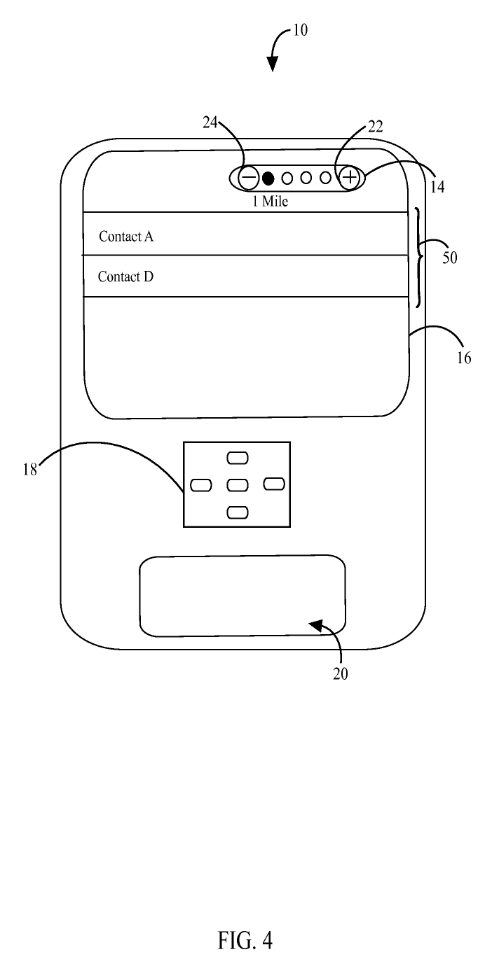

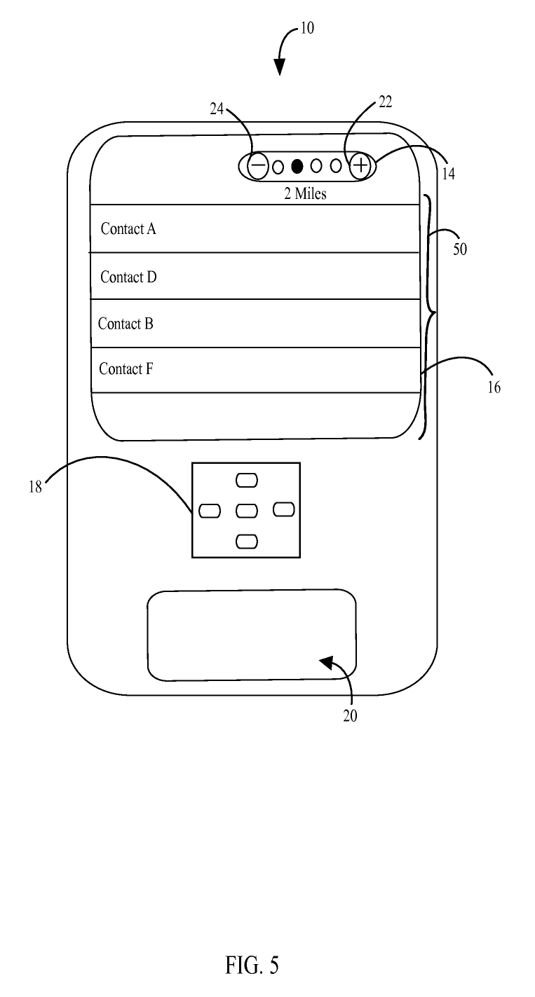

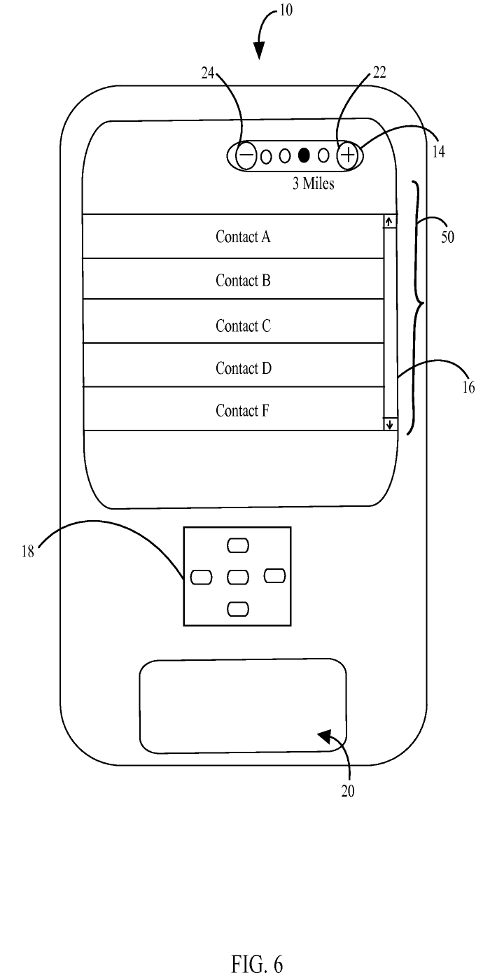

FIGS. 4, 5 and 6 depict a front view of a hand-held communications device 10 that displays a selected active proximity search range along with the corresponding populated display results 50. The active proximity search range, which is displayed as a sliding scale, includes a numeric indication of the magnitude of the active proximity search range in miles. In operation, the user can adjust the active proximity search range to a desired search range. For example, the active proximity search range can be expanded from 1 mile to 5 miles using the GeoData Bar without navigating to any other windows or menus. In the example of FIG. 4, the active proximity search range is set at 1 mile and only the contacts that are within the 1 mile active proximity search range are displayed. In particular, contacts A and D are the only active contacts within the active proximity search range and thus are the only contacts displayed. In the example of FIG. 5, the active proximity search range is set at 2 miles and only the active contacts that are within the 2 mile active proximity search range are displayed. In particular, contacts A, D, B, and F are the only active contacts within the active proximity search range and thus are the only contacts displayed. In the example of FIG. 6, the active proximity search range is set at 3 miles and only the active contacts that are within the 3 mile active proximity search range are displayed. In particular, contacts A, B, C, D, and F are the only active contacts within the active proximity search range and thus are the only contacts displayed. In an embodiment, the contacts are sorted by distance away from the user, with the closest contact to the user being listed first (e.g., at the top of the list) and the farthest contact from the user being listed last (e.g., at the bottom of the list). In an embodiment, there may be other contacts within the active proximity search range that have not agreed to share proximity information. These contacts are considered non-active, which is in contrast to the contacts that have agreed to share proximity information, i.e., the active contacts. The non-active contacts do not show up in the search results that are displayed on the hand-held communications device.

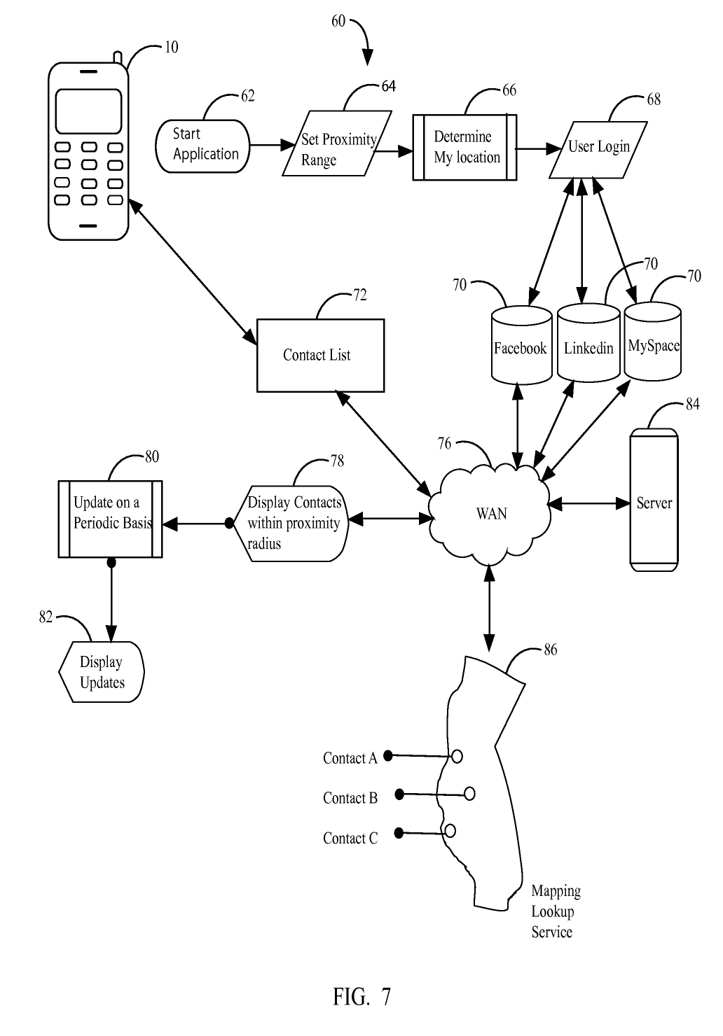

FIG. 7 depicts a top level diagrammatic perspective view of a system and method for utilizing a proximity-based application in an aggregated social networking platform. At block 62, a user initiates a session by starting the proximity-based social networking application. At block 64, the user sets the proximity range by adjusting the GeoData Bar 14 and at block 66, when the proximity range is set, the hand-held communications device's 10 position (e.g., longitude and latitude) is pushed to server 84, thereby determining the physical location of the device 10. At block 68, the user (not shown) logs in to the proximity-based application to allow access to all relevant social networking accounts associated with the user's profile, user ID, and/or password. The proximity-based application is able to extract content from the social networking services 70 such as Facebook, Linkedin, MySpace or the like and from the contact list 72 on the hand-held communications device 10. The server 84 extracts intelligent search results based on the user's proximity, the active proximity search range, and the search preferences and transfers the extracted proximity-specific content to the hand-held communications device 10 by way of, for example, a wide area network (WAN) 76. At block 78, the proximity-specific content, e.g., active contacts, which are located within the proximity search range are displayed on the hand-held communications device. At block 80 the search results may be updated at a specified interval and at block 82 the modified active search results are displayed. In an embodiment, a mapping lookup service is rendered for locating the geographic position of the user and the people, places, and/or things that are of interest to the user.

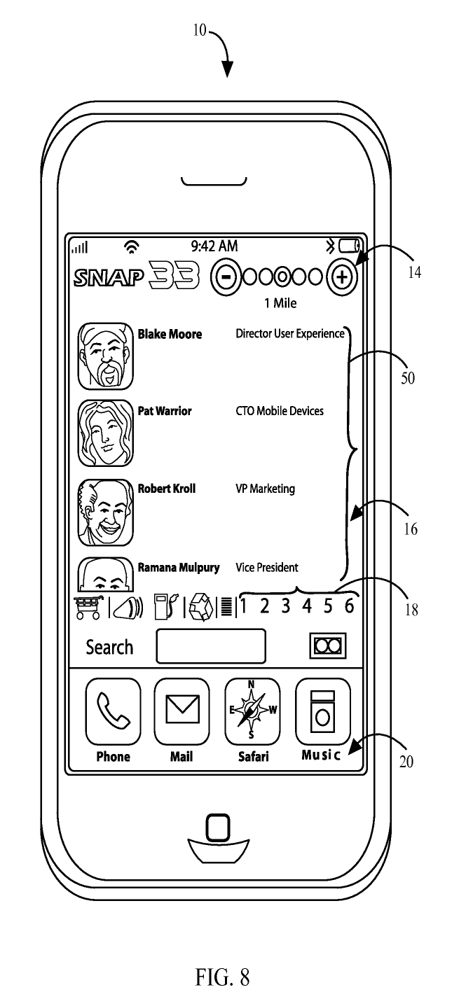

FIG. 8 depicts a perspective view of a hand-held communications device 10 configured to operate on a selected active proximity search range. The GUI of the proximity-based application includes a numeric indication of the active proximity search range set on a sliding GeoData Bar 14. The touch screen display 16 associated with this embodiment includes populated search results 50 of proximity-specific content that is within the selected search range set on the sliding GeoData Bar 14, for example 1 mile in this instance. The hand-held communications device 10 facilitates navigation through a list of multiple populated search results 50. The hand-held communications device 10 also includes a user interface 20 with a set of icons that provides additional functionality.

In an embodiment, widgets graphically represent proximity-based applications that obtain proximity-specific content that is specific to the widget and specific to the active proximity search range identified in the GeoData Bar. As with the contacts as described above, content that is accessible through the widgets is updated based on the continuously displayed search range of the GeoData Bar. The content-specific widgets enable one-touch or one-input access to specific proximity-dependent information. For example, a “gas” widget, as represented by the gas pump in FIG. 8, could be used to provide one-touch access to gas stations that are located within the currently displayed active proximity search range. If the active proximity search range is changed, the proximity-specific content associated with the widget is updated. The proximity-dependent widgets can be configured by the user to search for different types of information. As another example, a user can configure an environmentally sensitive widget, which is programmed to identify commercial businesses that maintain a certain environmental status, rating, and/or certification. Additionally, because the active proximity search range is applied to all of the proximity-based applications, all of the content associated with the widgets is specific to the currently set, and displayed, active proximity search range.

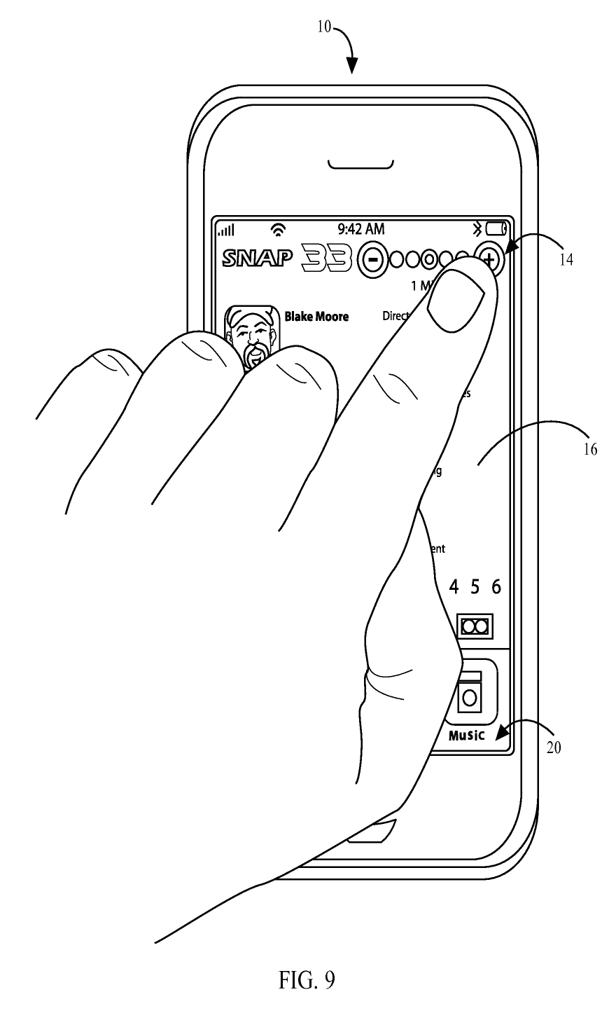

FIG. 9 depicts a perspective view of a hand-held communications device 10 that utilizes touch-screen technology to allow a user to navigate the plus icon 22 or minus icon 24 of the GeoData Bar to increase or decrease, respectively, the active proximity search range. The active proximity search range may be set on the sliding scale of the GeoData Bar 14 with a range decrease indicator on the left side and a range increase indicator on the right side of the sliding scale.

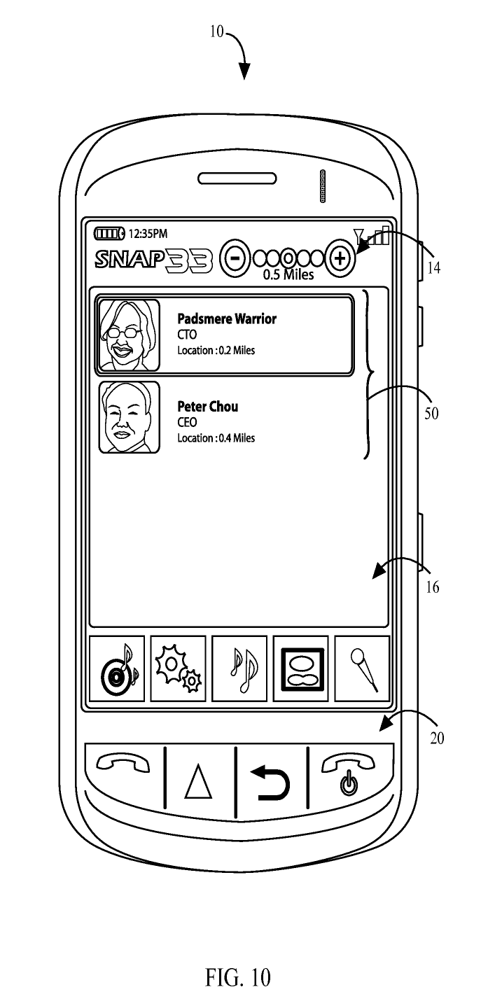

FIG. 10 depicts a perspective view of a hand-held communications device 10 that displays proximity-specific content in the form of contacts that are extracted from a plurality of social networking services 70. The proximity-specific content is displayed simultaneously with the active proximity search range and a numeric indication of the actual physical distance between the active contacts and the user.

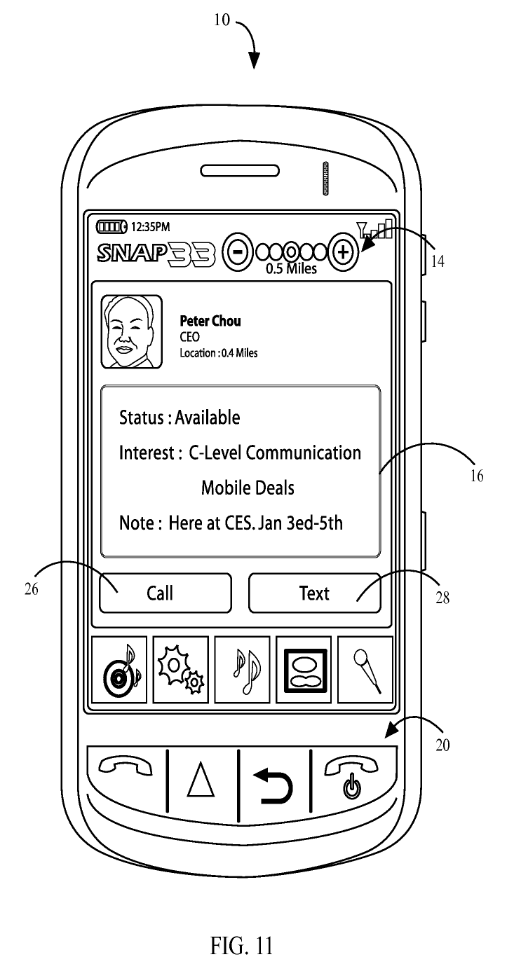

FIG. 11 depicts a perspective view of the hand-held communications device 10 of FIG. 10 that displays an expanded view of a selected contact from the proximity-based content of FIG. 10. In this embodiment, the expanded view of the selected contact includes the user's status, interests, and various notes. The interface 12 also facilitates the user to communicate with the selected active contact through a text message and/or a call by way of functional button 26 (call button) and functional button 28 (text button), each of which can be accessed and interacted with without navigating to additional windows or menus and all while the GeoData Bar is continuously and simultaneously displayed. Shortcuts to a plurality of add-on facilities may also be provided with the interface 12.

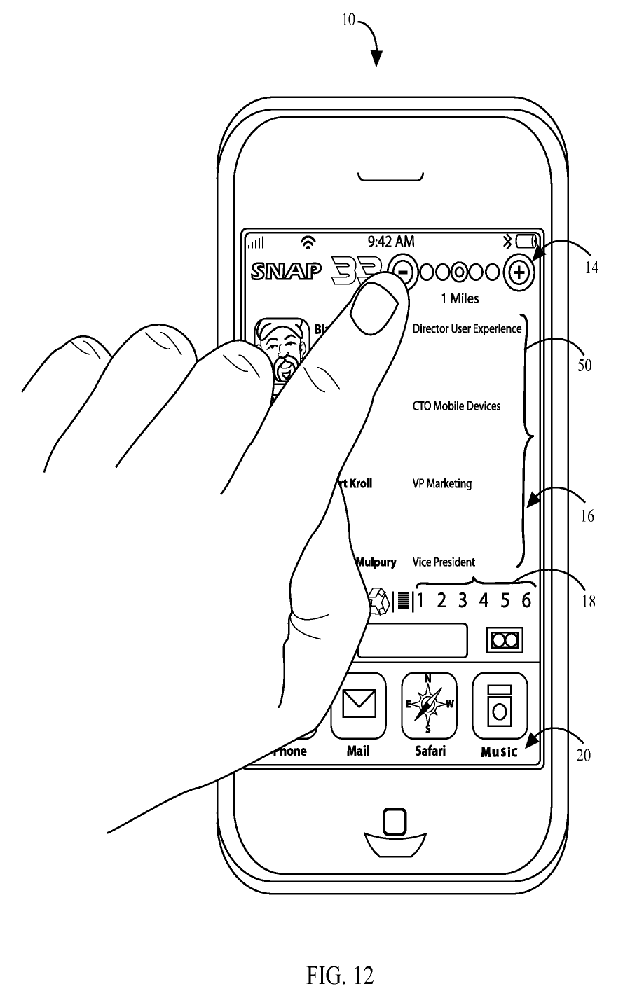

FIG. 12 depicts a perspective view of a hand-held communications device 10 with a touch screen user interface that enables a user to change the active proximity search range by simply touching the GeoData Bar and without navigating to additional windows or menus. The proximity-based application combines proximity information with user profiles and/or meta-tags and proximity awareness allows intelligent search and alert capabilities. The user can adjust the proximity search radius that they are interested in i.e., the search range may be expanded or constricted using the GeoData Bar 14. The plus and minus icons of the GeoData Bar 14 allow the user to increase or decrease the search range. In the embodiment of FIG. 12, the current proximity search range is always displayed between the plus icon and minus icon. The user has the option to place meta-tags inside the user profile to implement automated search and alerts. For example, a single person can put in their profile single, female and when in the proximity of someone looking for those characteristics an alert is sent to the hand-held communications device 10. The proximity information and user information for the profile are relayed to the server 84.

In an embodiment, a hand-held communications device includes a proximity-based ad incentive application, which enables a proximity-based advertisement model that operates using the active proximity search range that is set and displayed on the hand-held communications device. In an embodiment, consumers or end users are paid or rewarded for viewing advertising content on their hand-held communications device. End users receive currency (e.g., money and/or reward points) that can be emailed to the user in the form of coupons or money on a debit card. In operation, a user receives an ad on the user's hand-held communications device and when the user views the add on the user's hand-held communications device, viewing information is sent to an ad server. The server pushes viewing results to content providers for calculating a reward value for viewing the advertisement. When the user (and the hand-held communications device) comes into proximity of a retailer whose products the user is interested in, advertising for the retailer is pushed to the user. In an example, if the user wants to buy a purse and a retailer has advertising for a purse, when the user comes into a range, which is specified by the active proximity search range, the advertisement can be sent to the user's hand-held communications device. The advertising content that is received is a function of the active proximity search range. For example, advertisements can be limited to only those retailers that have a store located within the active proximity search range. In an embodiment, the proximity-based ad incentive application enables the hand-held communications device 10 to communicate with a plurality of content providers, for example advertisers to provide information on viewing statistics of relative content by the users in order to reward the users based on statistics. The content providers need to store their proximity settings and meta-tags on the server. Therefore, the server knows when the user comes in proximity to at least one searched proximity-based content with matching tags.

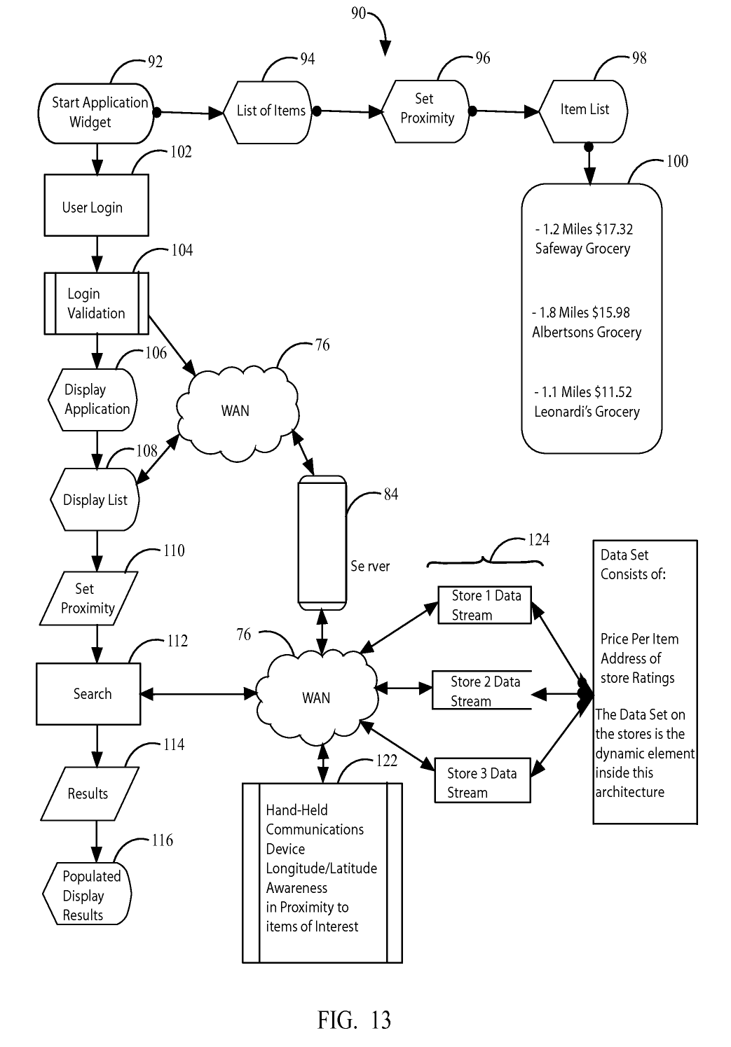

FIG. 13 depicts proximity-based widget logic that utilizes a GeoData Bar 14 in a hand-held communications device 10 to set the active proximity search range of the widget logic. Proximity in collaboration with widgets and real-time access renders smart widgets. The smart widgets are available at the presentation layer on the hand-held communications device 10. When a hand-held communications device 10 comes into proximity with a matching entity such as a venue with matching meta tags or data for which a widget is parsing relevant data and current time searches are being performed, the hand-held communications device 10 pushes this bundled query to the server 84 which returns results based on the data set sent to the server 84.

The search range of the proximity-based widgets is controlled by the GeoData Bar 14. In operation, a widget application is started at block 92 wherein the user formulates at least one search criteria, which may include a list of items, block 94. At block 96, the active proximity search range is set using the GeoData Bar 14. At block 98, the search results of matching items are compiled and at block 100 details regarding the search results are displayed.

At block 102, the user accesses the widget presented with results from the last parameter input inside the widget through state retention, wherein the state retention is the last known settings of the device 10. The user may change the proximity search range with the GeoData Bar 14 and the display 16 will subsequently re-render updated results. As the user logs on, the user's identity is validated by the server at block 104. The validation process includes a set of corresponding operations performed on the server 84 and the validation information is transferred through a WAN 76. The search results from previous searches are displayed at block 106 and the corresponding search list is rendered on the display at block 108. The user has the option to re-perform the existing search from its current location or to perform a new search from the same or different location.

At block 110, the active proximity search range is set by the user using the GeoData Bar and at block 112, a search is conducted to find matching proximity-specific content, wherein the wireless device will access the WAN 76, which talks to the server 84 to obtain the latitude and longitude of the hand-held communications device as at block 122 and pulls back search results as indicated at block 114 within the proximity parameter set for the search. The search results returned are based on the search criteria, for example, a user can get information on stores within a specified proximity search range or specific products or services as generally indicated at 124. The user can view a data set that includes ratings and other information relevant to the specific products or services. The data set relevant to specific products or services is the dynamic element inside the architecture. The extracted populated search results are presented at block 116 with a sort by option in a list format.

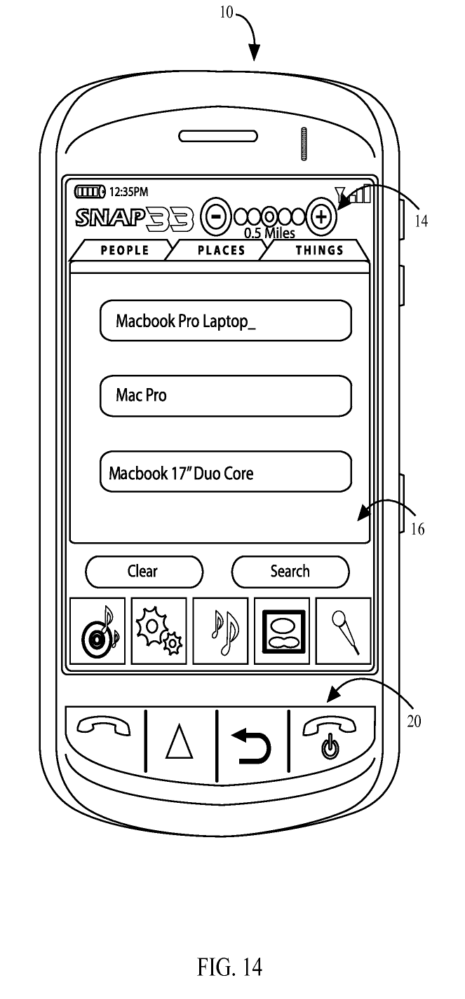

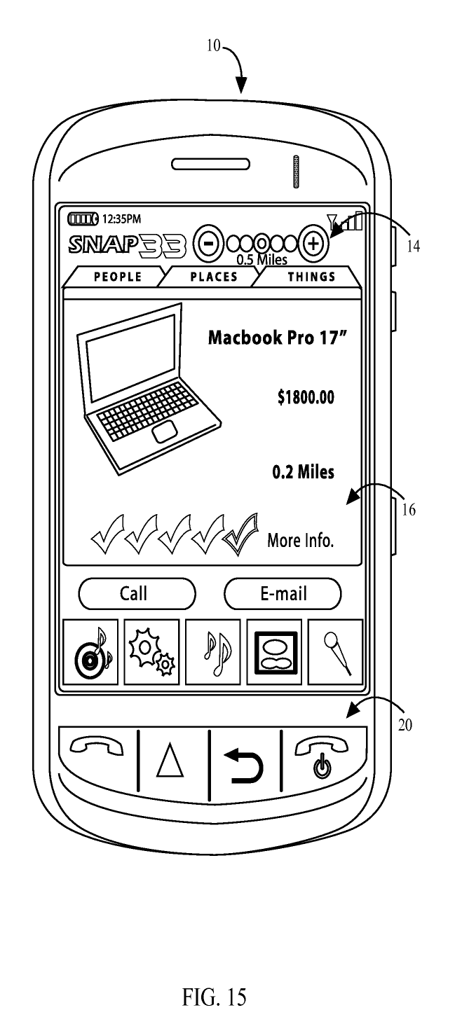

FIGS. 14 and 15 illustrate a proximity-based application for locating things, such as items for sale, which is implemented on a hand-held communications device 10. In an embodiment, a seller of goods identifies the goods and location information is associated with the goods. The user of the hand-held communications device specifies search preferences for specific goods and then sets the active proximity search range. Items that match the search preferences and that are within the active search proximity range (as identified by the GeoData Bar) are simultaneously displayed along with the active proximity search range. When the active proximity search range is changed, the proximity-specific content is updated to include all of the content that matches both the search preferences and the new active proximity search range. In the embodiment of FIG. 14, the proximity-specific application includes category-specific tabs that enable the user to toggle between different categories of proximity-specific content. All of the content associated with each tab is specific to the active proximity search range identified on the GeoData Bar. The combination of the category-specific tabs and the simultaneously displayed active proximity search range enables a user to easily toggle between categories and search ranges without navigating to new windows or menus. This feature is especially useful for hand-held communications devices, which are often used while the user is performing other functions such as driving an automobile. FIG. 14 illustrates various listings for computers that are offered for sale and that are located within the active proximity search range of 0.5 miles. FIG. 15 illustrates an expanded view of one of the listings after the listing has been selected by the user. The expanded view provides additional details about the item, including, for example, price, distance from the user, and contact options (call/text).

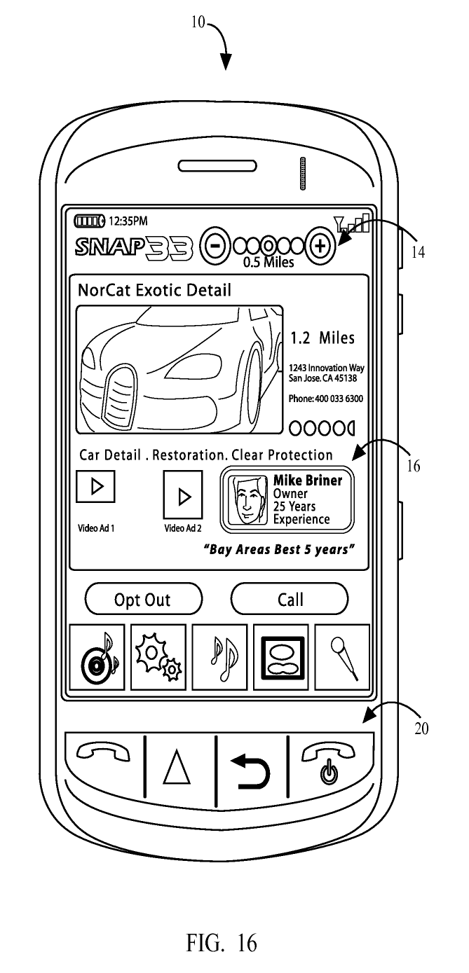

FIG. 16 depicts a perspective view of a hand-held communications device 10 that displays intelligent search details and a numeric indication of the physical location of a proximity-specific place. Retail stores or other individuals also store their proximity settings and meta-tags on the server. Therefore, the server 84 knows when one user comes into the specified proximity of another user with matching tags. The proximity-based application updates the location of the hand-held communications devices 10 on a predefined basis or timeline. The hand-held communications devices 10 are able to communicate through conventional wireless methods, wireless access points or WANS.

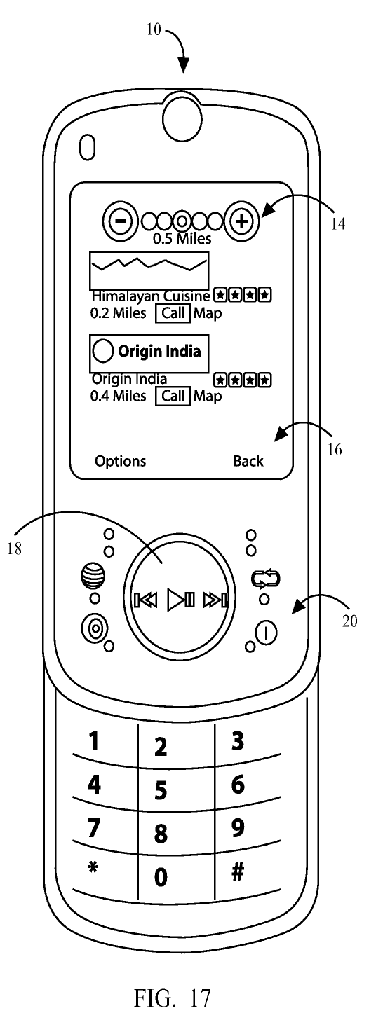

Although various examples of touch screen implementations of the proximity-based application have been described, other non-touch screen implementations are possible. FIG. 17 depicts a perspective view of a non-touch screen hand-held communications device 10 that displays populated search results 50 of proximity-specific places within a selected active proximity search range. The hand-held communications device 10 includes a plurality of icons such as call and map that enable the user to contact and locate proximity-specific content.

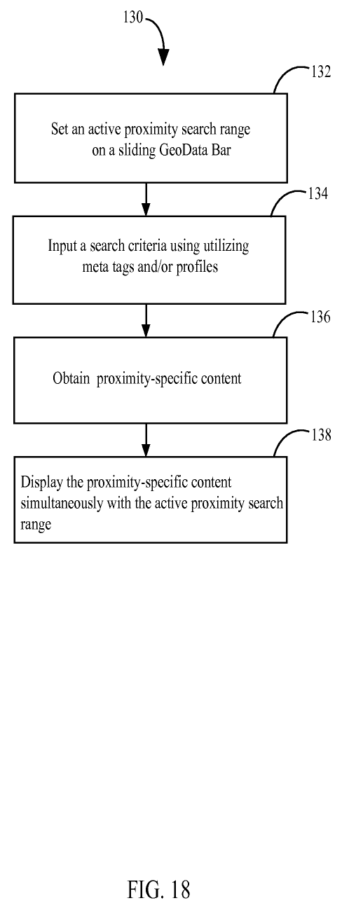

FIG. 18 depicts an operational flow chart 130 of a proximity based application on a hand-held communications device 10 for displaying the proximity-specific content that falls within the active proximity search range based on the settings of the GeoData Bar 14. At block 132, a proximity search radius of an active proximity search is set. At block 134, a search criterion utilizing meta tags and/or profile is input. At block 136, an intelligent search is performed and proximity-specific content is obtained that matches with the search criterion. At block 138 a populated result of the intelligent search conducted as at block 136 is displayed simultaneously with the active proximity search range.

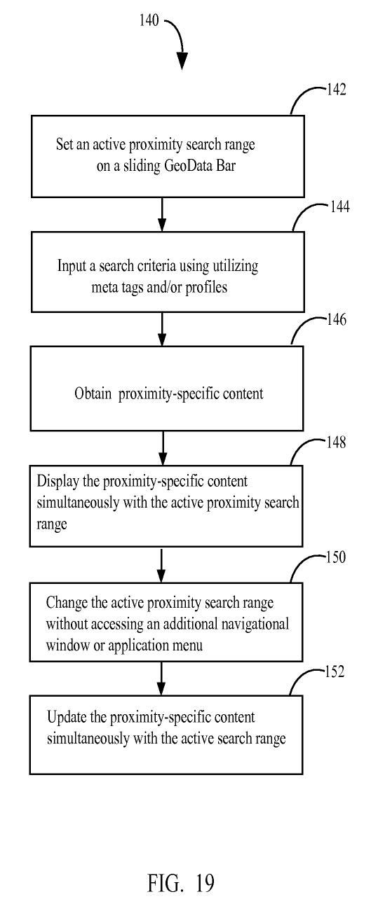

FIG. 19 depicts an operational flow chart 140 of a proximity based application on a hand-held communications device 10 for displaying the proximity-specific content simultaneously with updated proximity-specific content in accordance with changes in the active proximity search range set on the GeoData Bar 14. At block 142, an active proximity search range is set on a sliding GeoData Bar. At block 144, a search criterion utilizing meta tags and/or profile is input. At block 146, an intelligent search is performed to obtain relevant matches with the search criterion and the search result is displayed as indicated at block 148. The user can change the active proximity search range without accessing any additional navigational window or application menu as at block 150. At block 152, updated results of the intelligent search are displayed simultaneously with the active proximity search range.

Although specific embodiments of the invention have been described and illustrated, the invention is not to be limited to the specific forms or arrangements of parts as described and illustrated herein. The invention is limited only by the claims.

What is claimed is:

1. A method for operating a proximity-based application on a hand-held communications device, the method comprising:
displaying an active proximity search range on a display of the hand-held communications device;
obtaining proximity-specific content that falls within the active proximity search range; and
displaying the proximity-specific content that falls within the active proximity search range on the display of the hand-held communications device simultaneously with the active proximity search range.

2. The method of claim 1 further comprising changing the active proximity search range without entering an additional navigation window or an additional application menu.

3. The method of claim 1 further comprising displaying the active proximity search range on the display of the hand-held communications device as the proximity-specific content is updated in response to the change in the active proximity search range.

4. The method of claim 1 further comprising interacting with the proximity specific content while the active proximity range is displayed on the hand-held communications device.

5. The method of claim 1 wherein the active proximity search range is displayed as a sliding scale.

6. The method of claim 1 wherein the active proximity search range includes a numeric indication of the magnitude of the active proximity search range.

7. The method of claim 6 wherein the numeric indication is in miles or kilometers.

8. A hand-held communications device comprising:
a display for displaying a graphical user interface of an application;
a proximity-based application configured to:
display an active proximity search range on the display;
obtain a proximity-specific content that falls within the active proximity search range; and
display the proximity-specific content that falls within the active proximity search range on the display simultaneously with the active proximity search range.

9. The hand-held communications device of claim 8 wherein the proximity-based application is further configured so that the active proximity search range, which is displayed on the display, can be changed without entering an additional navigation window or an additional application menu.

10. The hand-held communications device of claim 9 wherein the proximity-based application is further configured to display the active proximity search range on the display of the hand-held communications device as the proximity-specific content is updated in response to a change in the active proximity search range.

11. The hand-held communications device of claim 8 wherein the proximity-based application is further configured to allow a user to interact with the proximity-specific content while the active proximity search range is displayed on the hand-held communications device.

12. The hand-held communications device of claim 8 wherein the proximity-based application is further configured to display the active proximity search range as a sliding scale.

13. The hand-held communications device of claim 12 wherein the proximity-based application is further configured to display a numeric indication of the magnitude of the active proximity search range.

14. The hand-held communications device of claim 14 wherein the numeric indication is in miles or kilometers.

15. The hand-held communications device of claim 12 wherein the proximity-based application is further configured to display the active proximity search range as a sliding scale with a range decrease indicator on the left side of the sliding scale and a range increase indicator on the right side of the sliding scale.

16. A hand-held communications device comprising:
a display for displaying a graphical user interface of an application;
a proximity-based social networking application configured to:
display an active proximity search range on the display; obtain information related to people from a specified social network that are currently located within the active proximity search range; and
display an indication of the people that are currently located within the active proximity search range on the display simultaneously with the active proximity search range.

17. The hand-held communications device of claim 16 wherein the proximity-based social networking application is further configured so that the active proximity search range, which is displayed on the display, can be changed without entering an additional navigation window or an additional application menu.

18. The hand-held communications device of claim 17 wherein the proximity-based application is further configured to display the active proximity search range on the display of the hand-held communications device as the proximity-specific content is updated in response to a change in the active proximity search range.

19. The hand-held communications device of claim 16 wherein the proximity-based application is further configured to allow a user to interact with the proximity-specific content while the active proximity range is displayed on the hand-held communications device.

20. The hand-held communications device of claim 16 wherein the proximity-based application is further configured to display the active proximity search range as a sliding scale with a numeric indication of the magnitude of the active proximity search range in miles or kilometers.

21. A method for operating a proximity-based application on a hand-held communications device, the method comprising:
displaying an active proximity search range on a display of the hand-held communications device, wherein the active proximity search range is displayed as a sliding scale that includes a numeric indication of the magnitude of the active proximity search range in miles or kilometers;
obtaining proximity-specific content that falls within the active proximity search range;
displaying the proximity-specific content that falls within the active proximity search range on the display of the hand-held communications device simultaneously with the active proximity search range;
changing the active proximity search range without entering an additional navigation window or an additional application menu;
updating the proximity-specific content that is displayed on the display while the active proximity search range is simultaneously displayed on the display of the hand-held communications device; and
interacting with the displayed proximity-specific content while the active proximity range is simultaneously displayed on the display of the hand-held communications device.

22. A hand-held communications device utilizing a storage media for storing computer readable instructions, wherein the computer readable instructions when implemented on a computer, cause the computer system to:
display an active proximity search range on a display of the hand-held communications device;
obtain a proximity-specific content that falls within the active proximity search range; and
display the proximity-specific content that falls within the active proximity search range on the display of the hand-held communications device simultaneously with the active proximity search range.
